(19) United States
(12) Patent Application Publication
(10) Pub. No.: US 2007/0053214 A1
(43) Pub. Date: Mar. 8, 2007

(54) Power system and method of controlling

(75) Inventor: Alain Fernand Marie-Louise Coorens, Bruges (BE)

Correspondence Address: PHILIPS INTELLECTUAL PROPERTY & STANDARDS, P.O. BOX 3001, BRIARCLIFF MANOR, NY, 10510, US

(73) Assignee: KONKNKLIJKE PHILIPS ELECTRONICS N.V., Eindhoven (NL)

(21) Appl. No.: 10/570,293

(22) PCT Filed: Aug. 24, 2004
(86) PCT No.: PCT/IB04/51550

§ 371 Date: Feb. 28, 2006

(30) Foreign Application Priority Data
Sep. 3, 2003 (EP) 03103274.1

(51) Int. Cl. H02M 1/00

(52) U.S. Cl. 363/49

(57) ABSTRACT

In a start-up mode (MS), at a start instant (t3, t13), a power converter (11) starts operating. After a predetermined period of time (T2, T12) from the start instant (t3, t13) it is checked whether the output voltage (Vo) of the power converter (11) has a desired value or not. If not, a protection mode (M3) is entered, otherwise the normal operating mode (M2) is entered. During the normal operating mode (M2), it is checked whether a drop in the output voltage (Vo) occurs. If yes, firstly, the power converter (11) is brought into the offmode (M1). Secondly, the power converter (11) is brought into the start-up mode (MS). If, after the restart, the output voltage (Vo) has the desired value, the earlier detected drop of the output voltage (Vo) was most likely due to a drop of the mains voltage (Vm) at the input of the power converter (11) and the normal operating mode (M2) can be resumed. If, after the restart, the output voltage (Vo) does not have the desired value, the earlier detected drop of the output voltage (Vo) was most likely due to a failure and the protection mode (M3) is entered. Now, the power converter (11) is not allowed to enter the start-up mode (MS) at all, or only after a relatively long period of time.

### FIELD OF THE INVENTION

The invention relates to a method of controlling a power system, a power system comprising a power converter, and an electronic apparatus comprising a power system.

### BACKGROUND OF THE INVENTION

In television receivers, it is common practice to use a main controller unit which comprises a microprocessor to receive user commands and to control the functions of the system. The main controller may also be used to control the power converter system which comprises the power converter(s) supplying the power supply voltages required by the circuits of the television receiver. This includes controlling the instants of on/off switching of the power converter(s) if a well defined on-off sequence is required. It also may include the monitoring of output voltage(s) of the power converter(s) to optimize the start-up and the switch-off behavior of the receiver, and to guarantee the safety of the receiver if the power converter or a circuit connected to the power converter fails.

Two contradictory design criteria for controlling the power converter system exist. Firstly, the receiver should cope with drops of the mains voltage (also referred to as mains dips) on the mains input of the power converter system with as little disturbance or user interaction as possible. Such a mains dip is detected with a mains input detection circuit connected to the input of the power converter system to check the level of the mains voltage. Secondly, when an output voltage of the power converter system drops below a reference level (also referred to as the occurrence of an output dip), the main controller should detect whether this output dip is due to a mains dip or not. The main controller has to differentiate between an output dip which reflects a power converter failure and an output dip due to a mains dip. If a power converter failure is detected, the main controller should enter the receiver into a protection mode wherein a safe situation exists. Usually, in the protection mode the power converter system is switched off and prohibited to be switched on at all or during a relatively long period in time.

So, if the main controller in correctly puts the receiver in the protection mode, the user is confronted with the problem that the receiver is unnessarily turned off for a relatively long time or needs to take some actions in order to restart the receiver.

### SUMMARY OF THE INVENTION

It is an object of the invention to provide a power system with an improved compromise between the behavior on a mains dip on the one hand and on a failure of the power system on the other hand.

A first aspect of the invention provides a method of controlling a power system as claimed in claim 1. A second aspect of the invention provides a power system comprising a power converter as claimed in claim 9. A third aspect of the invention provides an electronic apparatus comprising a power system as claimed in claim 10. Advantageous embodiments are defined in the dependent claims.

The power system in accordance with the first aspect of the invention comprises a power converter which can operate in several modes. In the off-mode, the power converter is switched off and supplies a zero voltage, or the power converter is in a standby state wherein a low output voltage is available. In the start-up mode, the power converter is starting-up to enter the normal operating mode. In the normal operating mode, the power converter supplies the output voltage having its desired nominal value. In the protection mode, the power converter is prevented to enter the start-up mode at all, or at least for a sufficient long period of time.

The start-up mode may be initiated at a start instant by a user who indicates that an apparatus which comprises the power converter system has to start operating. The power converter starts operating at the start instant. After a predetermined period of time from the start instant it is checked whether the output voltage of the power converter has a desired value or not. If not, a protection mode is entered; otherwise the normal operating mode is entered.

During the normal operating mode, it is checked whether a drop in the output voltage occurs. If yes, the power converter is first brought into the off-mode and then the start-up mode is activated to restart the power converter. If, after the restart of the power converter, the output voltage has the desired value, the earlier detected drop of the output voltage was most likely due to a drop of the mains voltage at the input of the power converter and the normal operating mode can be resumed. If, after the restart, the output voltage does not have the desired value, the earlier detected drop of the output voltage was most likely due to a failure and the protection mode is entered. Now, the power converter is not allowed to enter the start-up mode at all, or only after a relatively long period of time.

The difference with known algorithms is that: (i) the failure detection which controls the entering of the protection mode is only active during the start-up mode and not during the on-mode, (ii) a detected output voltage drop during the on-mode will always lead to a restart of the power converter and never to the protection mode.

The power converter system in accordance with the invention does not require information about the mains voltage at the input of the power converter. The mains input detection circuit is a complex circuit due to the spread in the value of the mains voltage. This spread is in particular large if the receiver has to be able to cope with different mains voltage ranges (for example, 230V and 110V). Further, in mains separated power converter systems, such as generally used in television receivers or other mains fed consumer electronic apparatus, the mains input detector has to bridge the mains separation. This is required to be able to sense the mains voltage at the non-mains isolated side of the power converter and to supply a signal indicating the outcome of the sensing to the main controller at the mains isolated side of the power converter. This extra bridge across the mains separation increases safety risk, and hampers EMC (Electro Magnetic Compatibility) approbation because extra currents will flow via this bridge over the mains separation barrier.

In an embodiment in accordance with the invention as defined in claim 3, the power system will stay in the protection mode once this mode is entered. A restart of the system may only be possible after a user interruption or after repair of the system. This approach prevents dangerous situations to occur in a failed system.

In an embodiment in accordance with the invention as defined in claim 4, after the protection mode is entered, the power system will wait a predetermined period of time before the start-up mode is entered. Usually, this predetermined period of time is relatively long. After this relatively long period of time, the system automatically checks whether the failure is still present. If the failure is still present after a predetermined number of restarts, the system may decide to stop the attempts to restart the system. This approach might be advantageous if the failure was due to, for example, overheating. After some time, when the system cooled down it may operate without any problems. The relatively long period of time should be substantially longer than the period in time which lasts from the instant an output dip is detected to a restart instant at which the power converter is restarted.

In an embodiment in accordance with the invention as defined in claim 5, the power converter may be completely switched off in the protection mode, this is the safest mode. Alternatively, the power converter may operate in a reduced output mode wherein at least one voltage is present with a sufficient level to be able to indicate to the user that the system is in the protection mode, and to restart the system if this should be possible.

In an embodiment in accordance with the invention as defined in claim 6, information on the operation state of the circuit is stored before the power converter enters the off-mode. This information may be user defined, such as, for example, the brightness, contrast, and program channel, or other controllable functions of a television receiver or another electronic mains fed apparatus. The stored information is used to restore, during, or after the start-up mode, the state the circuit was in before the drop of the output voltage was detected. This has the advantage that the user does not require to interfere; the system itself restores the situation that existed before the output dip was detected.

In an embodiment in accordance with the invention as defined in claim 7, the system further sets a flag to indicate that the normal operating mode is entered. This flag will be reset if the off-mode is entered due to an external command. Usually, the external command will be a user command indicating to switch off the system or to bring the system in a standby state. If the power converter restarts due to a mains dip or a failure, the flag is not reset. Thus, if after the reset is detected that the output voltage has the desired value, and the flag was not reset, this means that the power converter is restarting and the stored information on the situation before the drop of the output voltage was detected is used in the now following normal operating mode.

In an embodiment in accordance with the invention as defined in claim 8, the system further sets a flag to indicate that the normal operating mode is entered. This flag will be reset if the off-mode is entered due to an external command. If the power converter restarts due to a mains dip or a failure, the flag is not reset. Thus, if after the reset is detected that the output voltage has the desired value, and the flag is reset, it is known that the power converter is starting due to an external command and not due to an output voltage dip. Now, default settings are used during the start-up mode. The default settings may be stored in a memory. It is also possible to enter the default values after has been detected that the output voltage has the desired level.

The electronic apparatus may be a television receiver or any other mains operated electronic product, for example, monitor, a DVD player or an audio amplifier.

These and other aspects of the invention are apparent from and will be elucidated with reference to the embodiments described hereinafter.

### BRIEF DESCRIPTION OF THE DRAWINGS

In the drawings:

FIG. 1 shows a flow diagram of a method of controlling a power system in accordance with an embodiment of the invention,

FIG. 2 shows another flow diagram of a method of controlling a power system in accordance with an embodiment of the invention,

FIG. 3 shows a block diagram of a power system in accordance with an embodiment of the invention,

FIG. 4 shows a block diagram of a power system in accordance with another embodiment of the invention,

FIG. 5 show timing diagrams indicating a flow of events in an embodiment of the power system in accordance with the invention, and

FIG. 6 show timing diagrams indicating a flow of events in an embodiment of the power system in accordance with the invention.

### DETAILED DESCRIPTION OF THE PREFERRED EMBODIMENT

The same references in different Figures refer to the same items which have the same function and operate in the same manner.

FIG. 1 shows a flow diagram of a method of controlling a power system in accordance with an embodiment of the invention. The system may enter the start-up mode or start-up phase MS via two different branches B1 or B2. The first branch B1 is entered if a user provides a command to start the system, the second branch B2 is entered automatically by the algorithm after a drop of the level of the output voltage Vo has been detected during the normal operating mode M2.

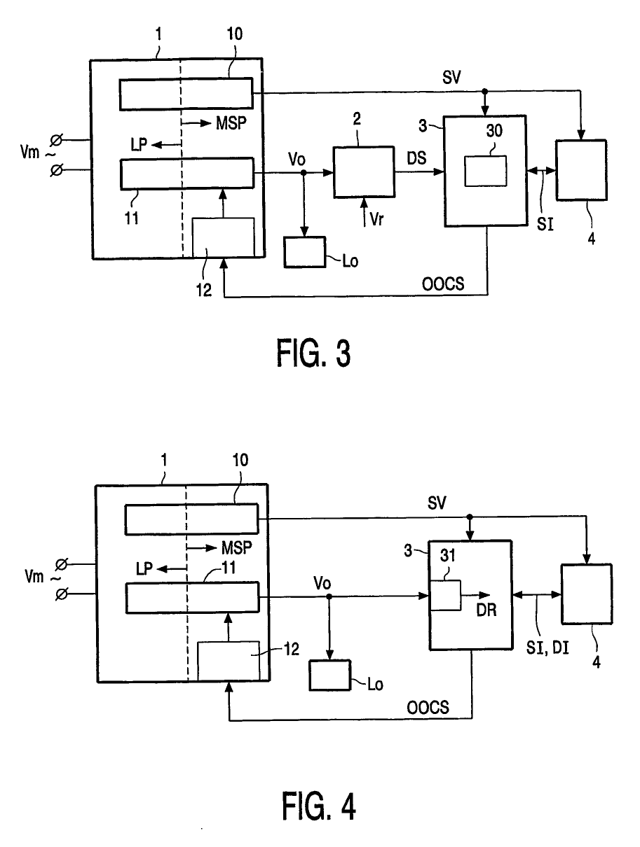

In the state SO, the system is in the off-mode M1. In the off-mode M1, the system may be completely switched off, for example by interrupting a mains switch such that the power system does not receive the mains input voltage Vm. Alternatively, in the off-mode M1, the system may be in a standby state. The power system may comprise a single power converter (not shown) which is during the stand-by mode in a reduced power mode wherein the output voltages have a lower level than in the normal operating mode M2. One of the output voltages has a suitably high level to allow part of the circuit Lo and processor 3 shown in FIG. 3 to be active. The active part of these circuits is able to detect a user command indicating that the normal operating mode M2 is desired and is able to start the power converter to obtain the normal operating mode M2. Alternatively, the power system may comprise a power converter system 1 which comprises several power converters 10, 11 (see FIG. 3). The power converter 10 which supplies the power supply voltage SV is active during the off-mode M1, the other power converter 11 is activated during the start-up mode or phase MS and supplies the output voltage Vo. The power supply voltage SV is supplied to the circuits 3, 4 which require power during the standby state.

In the now following, by way of example only, the operation of the power system is elucidated with respect to the situation that these two power converters 10 and 11 are present. A same algorithm is possible if a single power converter is used.

If, for example due to a user command, the off-mode M1 in the state S0 should be left, the branch B1 is entered and in step S1 the start-up mode MS is activated. The power converter 11 starts operating, this means that the output voltage Vo ramps up. The algorithm proceeds with the step S2 wherein the level of the output voltage Vo is checked a predetermined period of time after the start-up mode MS is activated. If at this check instant, the level of the output voltage Vo is correct, step S3 is entered, otherwise step S9 is entered. The step S2 may compare the level of the output voltage Vo with a reference level Vr. The level of the output voltage Vo is assumed to have the correct nominal value if it is higher than the reference level Vr.

In the step S9, the power converter 11 is switched-off to enter the protection mode M3 in step S10.

In the optional step S3 the system is initiated into a desired state and the normal operating mode M2 is reached in step S11 wherein the system is in normal operation. The initiation in the step S3 may be required to set the operation conditions desired or required in the normal operating mode M2. In step S12 is checked whether the system should be switched off due to a user or another external command EC, if yes, the algorithm proceeds to step So.

If the system is in the normal operating mode M2, in step S7 is checked whether the level of the output voltage Vo has the desired value. This checking is preferably performed continuously or intermittently within short time periods to be able to respond quickly if a drop of the output voltage Vo occurs. As long as no drop of the output voltage Vo is detected, the system stays in the normal operating mode M2. If a drop of the output voltage Vo is detected, in step S8 the system is switched off. Now, the system enters the off-mode M1 in step S13 and the algorithm proceeds with the step S1 via the branch B2. The algorithm will proceed in step S1 as elucidated earlier: the power converter 11 is started (in fact, now, restarted) to enter the start-up phase MS. In step S2 is checked whether the output voltage Vo has the correct level. If yes, the drop of the output voltage Vo most likely was due to a mains drop and the system can enter the normal operating mode M2. If no, the drop of the output voltage Vo most likely was due to a failure and in step S9 the power converter 11 is brought into the protection mode M3.

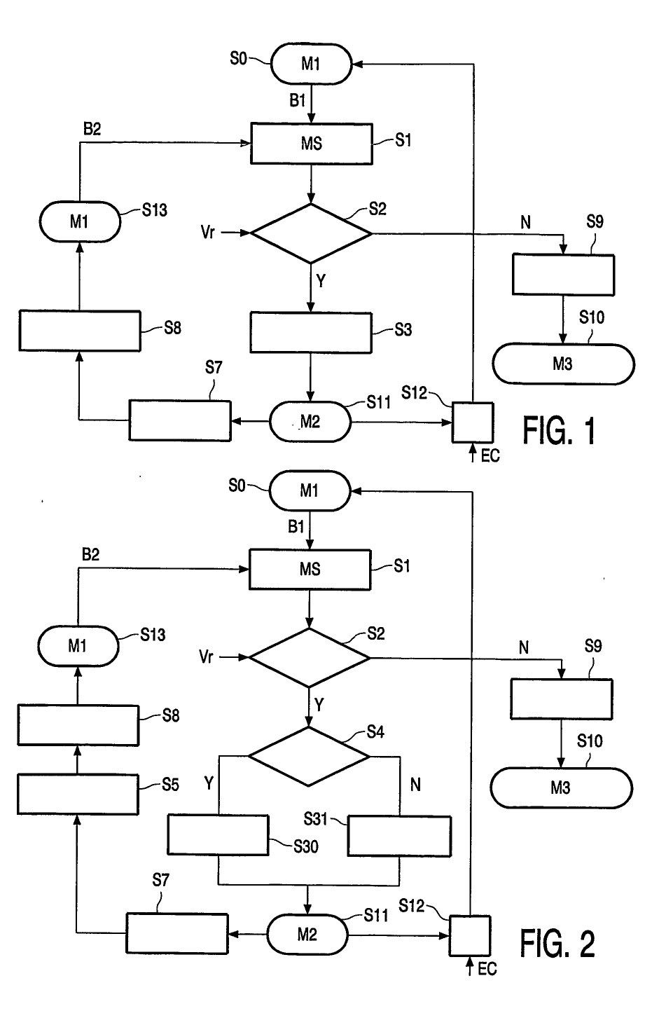

FIG. 2 shows another flow diagram of a method of controlling a power converter system in accordance with an embodiment of the invention. The references used in FIG. 2 which are equal to the references used in FIG. 1 have the same function and operate in the same manner. The difference of the algorithm shown in FIG. 2 with respect to the algorithm shown in FIG. 1 is that the steps S4 and S5 have been added, and that the step S3 is divided into the two steps S30 and S31. Further, in step S11, a flag is set to indicate that the normal operating mode M2 is reached, and in step S12, the flag is reset to indicate that the external command EC was the reason the power converter 11 is switched off.

If in step S7 a drop of the output voltage Vo is detected, in step S5, before in the step S8 the system is switched off, the information SI (see FIG. 3) on the operation state of the circuit Lo and/or the system is stored, for example in a memory 4 (see FIG. 3). This stored information SI defines the behavior of the circuit Lo and/or the system when in the normal operating mode M2.

If in the step S2 is detected that the output voltage Vo has the desired level, in step S4 the status of the flag is checked. If the flag is still set, the algorithm is performing a restart from the off-mode M1 of step S13 and in step S30 the circuit Lo and/or the system is initiated with the stored information SI and the normal operating mode M2 is entered in step S11. If the flag is reset, the algorithm is performing a cold start from the off-mode M1 of step M0 and in step S31 the circuit Lo and/or the system is initiated with default information DI and the normal operation mode M2 is entered in step S11. The default information may also be stored in the memory 4. The default information preferable defines a well known operating state of the circuit Lo and/or system.

FIG. 3 shows a block diagram of a power system in accordance with an embodiment of the invention.

The power system comprises a power converter system 1. The power converter system 1 comprises a power converter or regulator 10 which receives an AC input voltage Vm and supplies a power supply voltage SV, a power converter or regulator 11 which supplies the output voltage Vo, and an enable/disable circuit 12. The dashed line indicates the separation between the life part LP and the mains separated part MSP of the power converter system 1. The life part LP is the not mains separated part of the power converter system 1.

The power system further comprises a controller 3, a memory 4, an output level detector 2 and a load circuit Lo.

In this embodiment in accordance with the invention, the power converter system 1 comprises the power converter 11 which supplies the output voltage Vo which should be present during the normal operating mode M2 of the power converter system 1, and which should be inactive during the off-mode M1 of the power converter system 1. The power converter 10 has to supply the power supply voltage SV during the off-mode M1 to keep the controller 3 and the memory 4 active during the off-mode M1. The output voltage Vo is supplied to the load circuit Lo and to the output level detector 2.

The output level detector 2 compares the level of the output voltage Vo with a predetermined reference level Vr to supply a detection signal DS which indicates whether the level of the output voltage Vo is above the reference level Vr or not. The controller 3 receives the detection signal DS and supplies the on-off control signal OOCS to the enable/disable circuit 12. Usually, the controller 3 comprises a microprocessor 30 which performs the algorithm of one of the embodiments in accordance with the invention as discussed with respect to FIGS. 1 and 2. In an electronic apparatus, such as for example a television receiver, this microprocessor may be the main processor which handles the user commands and controls the circuits, such as the load circuit Lo, of the system.

The controller 3 communicates with the memory 4 to store and retrieve the stored information SI.

The operation of the system is already elucidated with respect to FIGS. 1 and 2. Therefore, the operation is elucidated in the now following briefly only. It has to be noted that the power converter which is controlled to change modes in the description of FIGS. 1 and 2 is in FIG. 3 the power converter 11. If the power converter 11 is in the on-mode M2, the output level detector 2 monitors the level of the output voltage Vo. The controller 3 receives the detection signal DS from the output level detector 2 to check whether the level of the output voltage Vo drops below the reference level Vr. If the controller 3 receives a detection signal DS indicating that the level of the output voltage Vo dropped below the reference level Vr, it first stores the information SI and then supplies the on/off control signal OOCS to control the enable/disable circuit 12 to switch off the power converter 11. After a predetermined time the controller 3 supplies the on/off signal OOCS to control the enable/disable circuit 12 to switch on the power converter 11 to start the start-up fase MS. A predetermined period of time later, the controller 3 checks whether the detection signal DS indicates whether the output voltage Vo has the desired level. If yes, the controller 3 retrieves the stored information SI and supplies it to the circuit Lo and/or the system. Now, the power converter 11 is in the normal operating mode M2. If no, the controller 3 supplies the on/off control signal OOCS to control the enable/disable circuit 12 to switch off the power converter 11. Now the protection mode M3 is entered. The controller 3 will not allow a restart of the power converter 11 at all, or within a relatively long period of time. This relatively long period of time is at least substantially longer than the period of time the power converter 11 is in the off mode M1 when switched off after a drop of the level of the output voltage Vo has been detected.

FIG. 4 shows a block diagram of a power system in accordance with an embodiment of the invention. This block diagram is based on the block diagram shown in FIG. 3. The output level detector 2 has been omitted. Now, the controller 3 comprises an analog to digital converter 31 which receives the output voltage Vo to supply a digital representation DR of the level of the output voltage Vo. The controller 3 uses this digital representation DR to check whether the output voltage Vo has the desired level. The reference level Vr may now be stored in the memory 4. The analog to digital converter 31 may be part of the microprocessor 30 shown in FIG. 3.

Further, the default information DI is stored in the memory. The use of the default information DI is elucidated with respect to FIG. 2.

The embodiment of the power system shown in FIG. 4 operates in the same manner as the embodiment shown in FIG. 3. The only difference is that the controller 3 uses the analog to digital converter 30 to detect a drop of the output voltage Vo instead of the output signal DS of the output level detector 2.

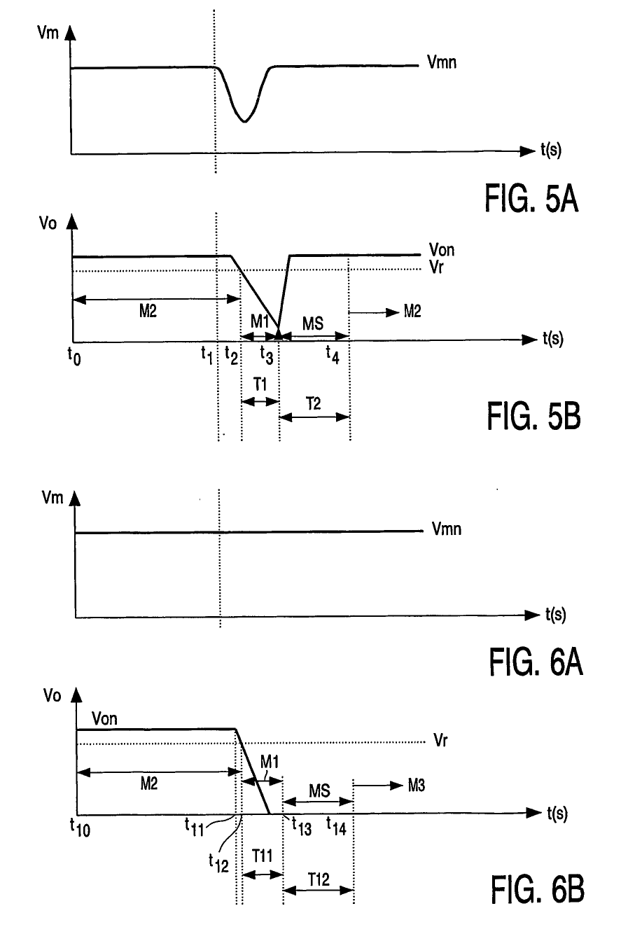

FIG. 5 show timing diagrams indicating an event flow in an embodiment of the power system in accordance with the invention. FIG. 5A shows the level of the mains voltage Vm in time t. FIG. 5B shows the level of the output voltage Vo in time t. FIG. 5 elucidate the algorithm if a mains dip occurs.

At the instant t0 the power system is in the normal operating mode M2, the mains voltage Vm has its nominal value Vmn and the output voltage Vo has its nominal value Von. At the instant t1, the mains voltage Vm starts to drop. Consequently, at the instant t2, the level of the output voltage Vo drops below the reference value Vr. The controller 3 switches off the power converter 11 and keeps the power converter 11 switched off during a predetermined period in time T1 which is selected longer than an expected duration of the drop of the mains voltage Vm. The predetermined period T1 lasts from instant t2 to t3 and is referred to as the off-mode or phase M1. Thus, the normal operating mode M2 lasted from instant t0 to instant t2. After this predetermined period in time T1, the controller 3 restarts the power converter 11 at the instant t3. After the predetermined period in time T2, at the instant t4, the controller 3 checks whether the output voltage Vo has a level higher than the reference level Vr. The predetermined period in time T2 which lasts from instant t3 to t4 is referred to as the start-up mode or phase MS. This period in time T2 is selected to be long enough for the power converter 11 to settle the output voltage Vo if the power converter 11 operates without a failure. Because at the instant t4, the level of the output voltage Vo is above the reference level Vr, the controller 3 knows that no failure is present and that the normal operating mode M2 is present which is allowed to continue.

FIG. 6 show timing diagrams indicating an event flow in an embodiment of the power system in accordance with the invention. FIG. 6A shows the level of the mains voltage Vm in time. FIG. 6B shows the level of the output voltage Vo in time. FIG. 6 elucidate the algorithm if a failure occurs.

At the instant t10 the power system is in the normal operating mode M2, the mains voltage Vm has its nominal value Vmn and the output voltage Vo has its nominal value Von. At the instant t11, a failure occurs causing the level of the output voltage Vo to drop while the mains voltage Vm has still its nominal value Vmn. Consequently, at the instant t12, the level of the output voltage Vo drops below the reference value Vr. The controller 3 switches off the power converter 11 and keeps the power converter switched off during a predetermined period in time T11 which is selected longer than an expected duration of a drop of the mains voltage Vm. The predetermined period T11 lasts from instant t12 to t13 and is referred to as the off-mode or phase M1. Thus, the normal operating mode M2 lasted from instant t10 to instant t12. After this predetermined period in time T11, the controller 3 restarts the power converter 11 at the instant t13. After the predetermined period in time T12, at the instant t14, the controller 3 checks whether the output voltage Vo has the desired level. The predetermined period in time T12, which lasts from instant t13 to t14, is referred to as the start-up mode MS. This period in time T12 is selected to be long enough for the power converter 11 to settle the output voltage Vo if the power converter 11 operates without a failure. Because at the instant t14, the level of the output voltage Vo is not above the reference level Vr, the controller 3 knows that a failure exists and thus commands the power converter 11 to switch off. The protection mode M3 is entered at the instant t14. Now, the controller 3 does not allow restarting the power converter 11 at all or during a relatively long period in time.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of controlling a power system comprising a power converter (11) for generating an output voltage (Vo) and having a start-up mode (MS) and a normal operating mode (M2), the method comprising during the start-up mode (MS):
starting (S1) the power converter (11) at a start instant (t3; t13),
checking (S2) a level of the output voltage (Vo) at a check instant (t4; t14) occurring a first predetermined period of time (T2, T12) after the start instant (t3; t13), and
controlling (S9) the power converter (11) to enter a protection mode (M3) if the level of the output voltage (Vo) is below a predetermined level (Vr) at the check instant (t4; t14), or to enter the normal operating mode (M2) otherwise,
the method comprising during the normal operating mode (M2):
checking (S7) whether the level of the output voltage (Vo) drops below the predetermined level (Vr), and
switching-off (S8) the power converter (11) at a switch-off instant (t2; t12) to obtain an off-mode (M1) if the checking (S7) indicates that the level of the output voltage (Vo) drops below the predetermined level (Vr), and
entering (S1) the start-up mode (MS) at a restart instant (t3; t13) occurring after the switch-off instant (t2; t12).

2. A method of controlling a power system as claimed in claim 1 wherein the restart instant (t3; t13) occurs a second predetermined period of time (T1; T11) after the switch-off instant (t2; t12).

3. A method of controlling a power system as claimed in claim 1, wherein the method further comprises the step of preventing (S10) the power converter (11) to enter the start-up mode (MS) when in the protection mode (M3).

4. A method of controlling a power system as claimed in claim 1, wherein the method further comprises the step of preventing (S10), during another predetermined period of time, the power converter (11) to enter the start-up mode (MS) when in the protection mode (M3).

5. A method of controlling a power system as claimed in claim 1, wherein during the protection mode (M3), the power converter (11) is switched off completely or is in a reduced output power mode.

6. A method of controlling a power system as claimed in claim 1, wherein the power system further comprises a circuit (Lo) for receiving the output voltage (Vo) as a supply voltage, and wherein the method further comprises
storing (S5), before entering the step of switching-off (S8), information on the operation state of the circuit (Lo) during the on-mode (M2) to obtain stored information (SI), and
supplying (S3) the stored information (SI) to the circuit (Lo) during or after the step of starting (S1) of the power converter (11).

7. A method of controlling a power system as claimed in claim 6, wherein the method further comprises
setting (S11) a flag when the power converter (11) is in the normal operating mode (M2),
resetting (S12) the flag when switching off the power converter (11) by an external command (EC),
checking (S4) a status of the flag, and
supplying (S30) the stored information (SI) to the circuit (Lo) only if (i) the checking (S2) of the level of the output voltage (Vo) indicates that the output voltage (Vo) is above the predetermined level (Vr), and (ii) the checking (S4) of the status of the flag indicates that the flag is set.

8. A method of controlling a power system as claimed in claim 6, wherein the method further comprises
setting (S11) a flag when the power converter (11) is in the normal operating mode (M2),
resetting (S12) the flag when switching off the power converter (11) by an external command (EC),
checking (S4) a status of the flag, and
supplying (S5) default operation information (DI) to the circuit (Lo) if (i) the checking (S2) of the level of the output voltage (Vo) indicates that the output voltage (Vo) is above the predetermined level (Vr), and (ii) the checking (S4) of the status of the flag indicates that the flag is reset.

9. A power system comprising a power converter (11) for generating an output voltage (Vo) and having a start-up mode (MS) and a normal operating mode (M2), the power system comprising:
means for starting (3) the power converter (11) at a start instant (t3; t13) of the start-up mode (MS),
means for checking (2) a level of the output voltage (Vo) at a check instant (t4; t14) occurring a first predetermined period of time (T2, T12) after the start instant (t3; t13), and
means for controlling (3) the power converter (11) to enter a protection mode (M3) if the level of the output voltage (Vo) is below the predetermined level (Vr) at the check instant (t4; t14), or to enter the normal operating mode (M2) otherwise,
the means for checking (2) being arranged for checking whether the level of the output voltage (Vo) drops below the predetermined level (Vr) during the normal operating mode (M2), the power system further comprises
means for switching-off (3) the power converter (11) at a switch-off instant (t2; t12) to obtain an off-mode (M1) of the power converter (11) if the means for checking (2) indicate that the level of the output voltage (Vo) drops below the predetermined level (Vr) during the normal operating mode (M2), and
means for entering (3) the start-up mode (MS) at a restart instant (t3; t13) occurring after the switch-off instant (t2; t12).

10. An electronic apparatus comprising a power system as claimed in claim 9 and a circuit (Lo) for receiving the output voltage (Vo) as a power supply voltage.

11. An electronic apparatus as claimed in claim 10, wherein the power system further comprises a storage means (4), and wherein the controller (3) is arranged for controlling the storage means (4) to store, before the means for switching off (3) switches off (S8) the power converter (11), information on the operation state of the circuit (Lo) during the on-mode (M2) to obtain stored information (SI), and for supplying the stored information (SI) to the circuit (Lo) during or after the means (3) for starting (S9) have restarted the power converter (11).
